(19) United States
(12) Patent Application Publication
(10) Pub. No.: US 2023/0394562 A1
(43) Pub. Date: Dec. 7, 2023

(54) PORTABLE INTERACTIVE OBJECT WITHIN A VIRTUAL ENVIRONMENT

(71) Applicant: Build a Rocket Boy Games Ltd., Edinburgh (GB)

(72) Inventor: Leslie Peter Benzies, Edinburgh (GB)

(21) Appl. No.: 18/330,042

(22) Filed: Jun. 6, 2023

Related U.S. Application Data
(60) Provisional application No. 63/349,504, filed on Jun. 6, 2022.

(51) Int. Cl. G06Q 30/0601; G06T 19/00; G06T 13/40

(52) U.S. Cl. CPC G06Q 30/0643; G06T 19/00; G06T 13/40; G06T 2200/24; G06T 2219/024; G06Q 50/01

(57) ABSTRACT

Systems, methods, and machine-readable media for controlling an interactive virtual environment. The system includes a computing device for generating a three-dimensional virtual environment including a first avatar representing a first user within the three-dimensional virtual environment, generating a portable interactive object of the first user at a first location within the three-dimensional virtual environment, the first location designated by the first user, and the interactive object interacting with one or more avatars representing respective users.

### RELATED APPLICATION INFORMATION

This patent claims priority from U.S. provisional patent application No. 63/349,504 entitled “PORTABLE MINI-GAME WITHIN A VIRTUAL ENVIRONMENT” filed Jun. 6, 2022, the entire content of which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to interactive three-dimensional computer-generated environments and, more particularly, to the viewing of and interaction with objects within such environments.

### Description of the Related Art

In the traditional internet context, a user may launch a chat application, such as Instant Messenger or Slack, to chat with other users. Alternatively, the user may engage in web browsing using software like Internet Explorer or Chrome. Further, the user may play a video game alone or may sign on to an online game to play a teams vs teams style game or a massively multiplayer online (MMO) game. Historically, such games were played using a two-dimensional displayed image which may represent a three-dimensional virtual environment. In this patent, the term “environment” means the virtual space in which a game or other activity occurs. With the current availability of consumer virtual reality headsets, many games are now played with a three-dimensional display of the three-dimensional virtual environment.

The metaverse is a somewhat vague set of concepts related to software and technology that is viewed as the next generation of the Internet. In this patent, the “metaverse” is specifically defined as an online environment to which users may enter (i.e. connect to) to engage in various and varied activities. The metaverse is, or will be, implemented as an immersive space, preferably a three-dimensional space, into which a user can enter. A user within the metaverse is commonly represented by a three-dimensional character, commonly called an “avatar”. Avatars indicate the position and activity of respective users. Once within the metaverse, a user theoretically could access all desired game types, content types, and engage in any community or solo activity that the user desires. In over-simplified terms, the metaverse may be a three-dimensional virtual environment that encompasses the three-dimensional virtual environments of many individual games. The metaverse is traditionally understood to be continuously evolving with new content and interactions and users being added. Ideally, a single metaverse will encompass all online activities, Alternatively, there may be multiple metaverses which may be, for example, hosted by different entities.

Many of the activities that may be present in the metaverse will require the presence of specific objects. For example, a shooter game may require a weapon and targets, and a chess game requires a board and chess pieces. Various regions within the metaverse may be dedicated to different activities. In some circumstances, a user located in a particular portion of the metaverse may want to participate in an activity where the required objects are not immediately available. In such situations, the user may relocate to another portion of the metaverse where the required objects are provided. Alternatively, users may bring the objects necessary to engage in a desired activity along with them as they move through the metaverse, as will be described subsequently.

### DESCRIPTION OF THE DRAWINGS

FIG. 1 is an overview of a system for accessing a three-dimensional virtual environment.

FIG. 2 is a block diagram of an exemplary computing device.

FIG. 3 is a functional block diagram of a system for accessing the three-dimensional virtual environment.

FIG. 4 is an example of three-dimensional avatars near a portable interactive object in a three-dimensional virtual environment.

FIG. 5 is a flowchart of a process for interacting with a portable interactive object in a three-dimensional virtual environment.

FIG. 6 is a flowchart of another process for interacting with a portable interactive object in a three-dimensional virtual environment.

FIG. 7 is a flowchart of another process for interacting with a portable interactive object in a three-dimensional virtual environment.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

Description of Apparatus

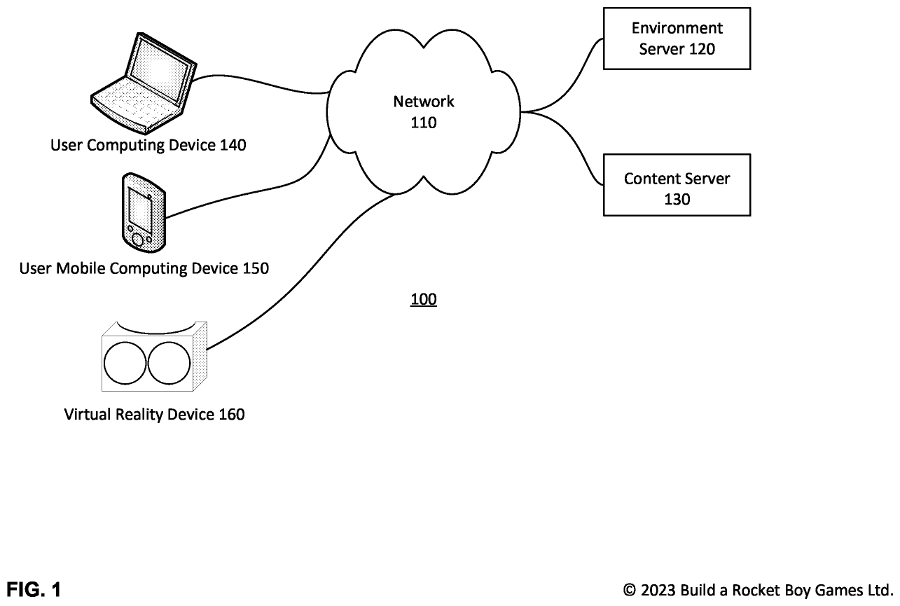

Referring now to FIG. 1, a system 100 for accessing a three-dimensional virtual environment includes an environment server 120, a content server 130, a user computing device 140, a user mobile computing device 150, and a virtual reality device 160; all interconnected by a network 110.

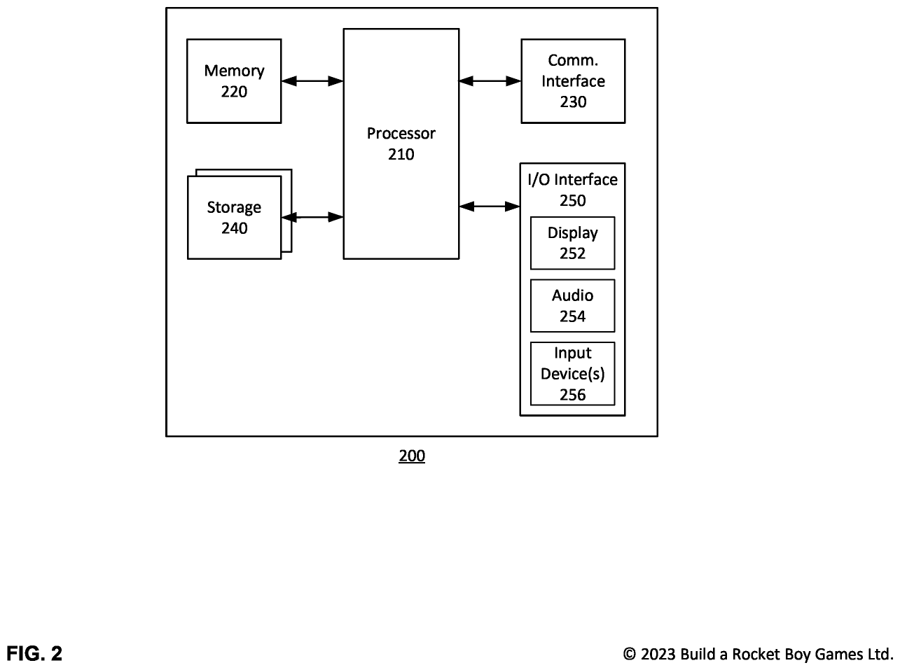

The environment server 120 is a computing device, which will be described further in conjunction with FIG. 2, or a group of computing devices. The environment server 120 is used to store three-dimensional models and any textures associated with the various three-dimensional models. These models may be player characters, environments in which the models move about, virtual automobiles, clothing, furniture, buildings, means of transport, displays, plants, and components of each of the foregoing.

The environment server 120 may act much like a traditional “game server” to provide a server into which one or more players may log in order to move about in a virtual world comprised of the associated art assets, models and textures. The environment server may primarily operate as an orchestrator of multiple players as they connect and interact with one another, and to ensure integrity of the process of login, and uniformity of the three-dimensional virtual environment (which may actually be rendered locally on each user's machine from a set of game assets and files).

The environment server 120 may be self-hosted, meaning operated by a company or entity that enables the functions and systems described herein. Alternatively, the environment server 120 may be on a shared resource service such as Amazon AWS or Microsoft Azure. Some or all of the environment server 120 may be hosted by the users of the system itself (e.g. a “chat” room made by players) so that users join their computer. In such cases, the environment server 120 or a portion thereof may actually be peer-to-peer hosted by one of the participants and merely orchestrated or controlled by a player.

The optional content server 130 is a computing device or a group of computing devices. The content server 130 stores and streams linear audio and/or video content for use within the three-dimensional virtual environment created by the environment server 120. For example, the content server 130 may stream video content to be displayed on a fixed or movable display within the virtual environment generated by the environment server 120. In this case, the content server 130 may be a streaming service like Netflix® or Hulu®. The content server 130 may stream audio content to be played by a fixed or portable audio system with the three-dimensional virtual environment.

In some cases, the content server 130 may be or be a part of the environment server 120. This may be the case, for example, when the environment server 120 is used to display a linear content version of an ongoing game (e.g. a stream of an first person shooter (FPS) game or massively online battle arena (MOB A) game being played elsewhere within the environment). Or, in other cases, the content server 130 may be one or more of the user's computing devices. So, a user may host a “movie night” by streaming a film or television show from their local library or together with a friend from an online streaming service. In such a case, the content server 130 may be locally hosted by a user.

The user computing device 140 is a computing device such as a personal computer, laptop computer, desktop computer or the like. The user computing device 140 may be a typical consumer computing device, lacking in any significant specialized capabilities. However, the user computing device 140 may include a GPU or an integrated GPU (e.g. integrated into a single chip with a CPU). The user computing device 140 is used by a user to connect to the environment server 120 to move an avatar about within a three-dimensional virtual environment generated by the environment server 120 (or, more accurately, on the user computing device 140 as directed by the environment server 120). The three-dimensional virtual environment itself may incorporate one or more display screens for display of linear content thereon built-in to the environment (e.g. large billboards, virtual “television” monitors, and the like).

The user mobile computing device 150 is effectively identical to the user computing device, though its form factor may be that of a mobile device. It may, for example, be a mobile phone, a smart phone, a tablet computer, or other, similar device. It is shown to indicate that in some cases a user mobile computing device 150 may be used in place of the user computing device 140. Likewise, the virtual reality device 160 is another computing device that operates in much the same way as the user computing device with the added capability of presenting a three-dimensional image of the three-dimensional virtual environment.

The network 110 may be or include the Internet.

FIG. 2 is a block diagram of an exemplary computing device 200, which may be or be a part of the environment server 120, the content server 130, the user computing device 140, the mobile computing device 150 or the virtual reality device 160 of FIG. 1. As shown in FIG. 2, the computing device 200 includes a processor 210, memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the input/output interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals. The application can perform the functions described herein.

The communications interface 230 may include one or more wired interfaces (e.g. a universal serial bus (USB), high definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media, such as media designed for long-term storage of data. The word “storage”, as used herein, explicitly excludes propagating waveforms and transitory signals.

The input/output interface 250, may include a display 256 and one or more input devices 256 such as a touch screen, keypad, keyboard, stylus or other input devices. The input/output interface 250 may include audio 254 input/output capability. A display 252 may also interact using the input/output interface 250. The processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device 200. That is, the software may be stored in electronic, machine readable media. These storage media include, for example, magnetic media such as hard disks, optical media such as compact disks (CD-ROM and CD-RW) and digital versatile disks (DVD and DVD±RW), flash memory cards, and other storage media. As used herein, a storage device is a device that allows for reading and/or writing to a storage medium. Storage devices include hard disk drives, DVD drives, flash memory devices, and others.

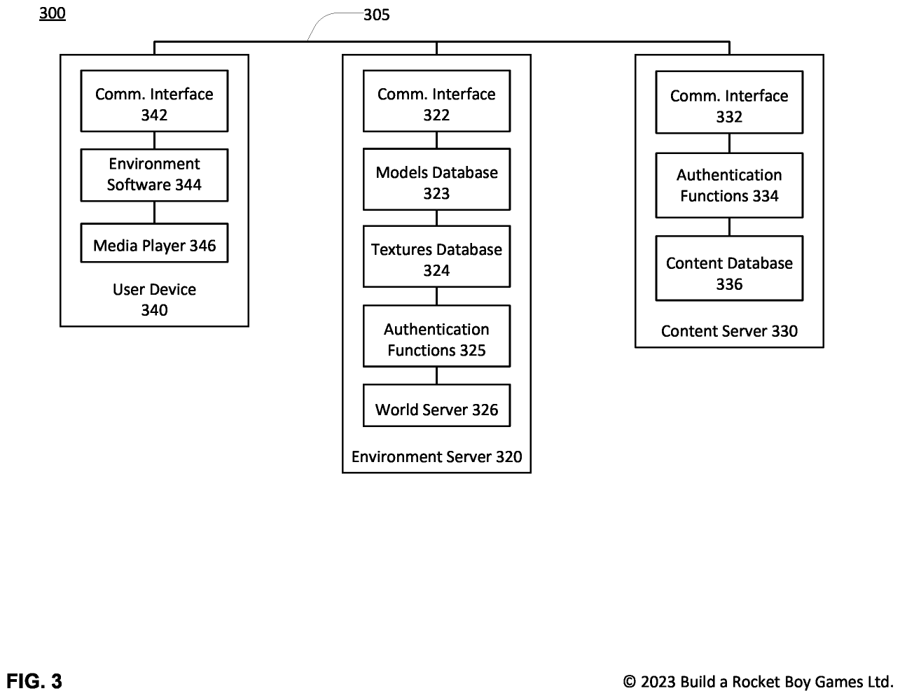

FIG. 3 is a functional block diagram of a system 300 for accessing a three-dimensional virtual environment. The system 300 includes an environment server 320, an optional content server 330, and a user computing device 340 interconnected by a network 305. The environment server 320 may be a version of environment server 120, the content server 330 may be version of server 130, and the user computing device 340 may be a version of device 140, 150 or 160. The mobile computing device and virtual reality device are not shown because their functions are substantially the same as the user computing device 340. These are functional elements, expressed in terms of their functionally. The functional elements shown in this figure may be physically divided or organized differently than shown from a functional perspective while still conforming to the overall intended functionality and purposes. The functions shown in this figure may be implemented in hardware or software or a combination of the two.

The environment server 320 includes a communications interface 322, a models database 323, a textures database 324, authentication functions 325, and a world server 326.

The communications interface 322 operates to enable communications between the interacting elements of the system like the content server 330 and the user computing device 340. The communications interface 322 may include the various hardware network components discussed above as a part of the computing device 200. However, it also may include application programming interfaces (APIs), unique network connectivity systems and data protocols used by the user computing device 340 and/or content server 330 to communicate with the environment server 320 securely and efficiently under the unique circumstances of the system 300.

The models database 323 stores the three-dimensional models used to generate the three-dimensional virtual environment. These models may be the maps of the world, the locations, the objects making up the world (e.g. cars, boats, trees, tables, chairs, clothing, etc.). The models database 323 also stores the models for the player avatars used within the world by all of the players. These avatars may be uniquely-designed individually by each player or may have elements drawn from groups of “components” making up the avatar bodies (e.g. sets of eyes, sets of arms, sets of legs, etc.).

The textures database 324 stores the textures used in conjunction with the three-dimensional models stored in the models database 323 and used the generate the three-dimensional virtual environment. The textures are applied by a three-dimensional engine to generate models with associated “skins” on those models. The textures appear as skin, clothing, tile on floors. Moving textures can even appear as television-like elements within the world or as animations on cars, avatars, and other elements of the generated three-dimensional virtual environment.

The authentication functions 325 ensure that users (e.g. using user computing device 340) logging into the environment server 320 are properly authenticated. This may be as simple as a typical login function with a password, but may also employ two-factor authentication, fingerprint authentication, or other, secure methods. This is in part because the accounts associated with a given user or player in a given environment may have some value, may be sold or traded to others or may simply represent a great deal of time, effort, and investment on the part of the player. The type of ever-present world available in some forms of three-dimensional virtual environments, such as so-called metaverse environments, can engender significant attachment to or identification with a player avatar. So, players may wish to have as secure a login process as possible to make sure that their avatars, and any digital belongings associated with that avatar, are secure.

The world server 326 orchestrates the other components of the environment server 320 to enable users connected to the environment server 320 to operate to generate the three-dimensional virtual environment for users connected to the environment server 310. The world server 326 may operate in much the same way as a game engine or network game server operates. Though shown as a single server, it may be many physical servers. The world server 326 enables multiple users to connect to the environment server 320 to experience the same game world or three-dimensional virtual environment simultaneously. To accomplish this, the world server 326 ensures authentication has taken place, loads the models and textures from the model database 323 and the texture database 324, and maintains an updating state for the overall game including player locations and movements and animations within the three-dimensional virtual environment.

The world server 326 may simultaneously operate multiple world “types” so that users can transition from, for example, racing game to fighting game to “hang out” area to special linear content experience (discussed below), and so on. In this way, a single or multiple servers may be employed. In cases with a larger server population or particular game types that are overpopulated, sharded servers may be employed to load balance the total user population in a given area or on a server. The world server 326 may dynamically allocate and deallocate physical server capacity dependent upon the current load or need either in aggregate or for particular experiences.

In cases where linear content is streamed or otherwise shown within a three-dimensional virtual environment, the world server 326 may operate to apply linear content from the content server 330 to a portion of the three-dimensional virtual environment (e.g. a display or screen within the virtual world) so that the content may be viewed or viewable “in” the three-dimensional virtual environment.

The content server 330 includes a communications interface 332, authentication functions 334, and a content database 336. Though shown as a single content server 330, there may in fact be many content servers, each hosted separately from one another. In other case, the user computing device 340 itself may be a content server 330 as well as operating to access linear content.

The communications interface 332 is primarily used to communicate requests for particular linear content from the user computing device 340 or the environment server 320 and to transmit the linear content requested to the environment server 320 and/or user computing device 340. The communications interface 332 may include the various hardware network components discussed above as a part of the computing device 200. However, it also may include application programming interfaces (APIs), unique network connectivity systems and data protocols used by the user computing device 340 and/or environment server 320 to communicate with the content server 330 securely and efficiently under the unique circumstances of the system 300.

The authentication functions 334 operate much the same as the authentication functions 325 of the environment server 320. However, these authentication functions 334 may be distinct from those of the environment server 320 in that they may involve authentication with a third party service (e.g. Netflix®) where streamed linear content or otherwise stored linear content is available for access. So, a user may be required to separately authenticate with a particular content server 330 in order to access the content database 336 and provide that data or that streamed content to the environment server 320 and the user computing device 340 for viewing. Accordingly, the authentication functions 334 may be implemented by a third party or rely upon the exchange of keys between the content server 330 and the environment server 320 and the user computing device 340 to enable the system 300 to operate to access linear content stored on the content server 330.

The content database 336 is a database storing the linear content for viewing by the user computing device 340 and/or the environment server. The linear content is preferably of a type that is suitable for streaming, reliant upon built-in redundancies in the encoding such that it may be readily streamed or transmitted over a network. Various forms of video content, particularly designed for compact, efficient encoding and streaming are known to those of skill in the art. Examples of suitable encoding schemes include H.264 and H.265.

The user computing device 340 is a computing device used by a user to access the environment server 320 and the content server 330. The user computing device 340 is shown as only a single device for example purposes, but a single environment server 320 and content server 330 can service numerous (hundreds or thousands) of simultaneous connections and interactions with user computing devices like user computing device 340. The user computing device 340 is commonly a desktop or laptop computer, but may be a mobile device or a virtual reality device or similar computing device. The user computing device 340 includes a communications interface 342, environment software 344 and a media player 346.

The communications interface 342 is primarily used to enable interaction of a player's avatar and software with the environment server 320 and to obtain and stream content from the content server 330. The communications interface 342 may include the various hardware network components discussed above as a part of the computing device 200. However, it also may include application programming interfaces (APIs), unique network connectivity systems and data protocols used by the user computing device 340 to communicate with the content server 330 or with the environment server 320 securely and efficiently under the unique circumstances of the system 300.

The environment software 344 is software for presenting the three-dimensional virtual environment served by the environment server 320 to the user computing device 340. Traditionally, the environment software 344 would be an implementation of a “game engine” software that integrates three-dimensional models, textures for those models, scripting to enable functions and interaction within the three-dimensional virtual environment, and various other functionality taking place within the environment server 320. The environment server 344 preferably integrates the authentication functions used by authentication functions 325 and 334 to enable the environment server 344 to access the world server 326 and content database 336 to enable the functions discussed herein. In a simplified sense, user may move a three-dimensional avatar about in a three-dimensional virtual environment, interact with the environment, and may stream or otherwise access linear content served by the content server 330 from within the three-dimensional virtual environment. Thereafter, the user may transition the player avatar to a new three-dimensional virtual environment based upon interaction with the linear content displayed within the three-dimensional virtual environment.

The media player 346 is software designed to play linear content. This software may be specialized in the sense that it operates within the three-dimensional virtual environment shown on the user computing device 340 so that a user may view the linear content played by the media player 346 from within the three-dimensional virtual environment, for example, on a virtual television display, a billboard or otherwise on a “screen” within the three-dimensional virtual environment for viewing by those users (each connected via one of the user computing devices 340) within the three-dimensional virtual environment.

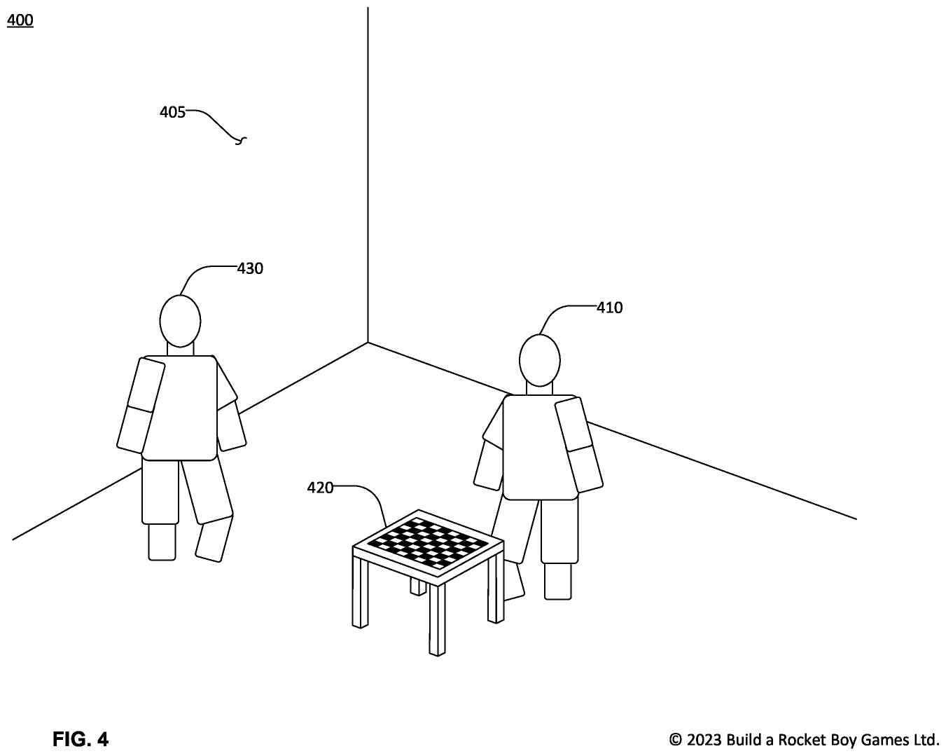

FIG. 4 is a simplified view of a particular location 405 within a three-dimensional virtual environment 400. At the location 405, a first user, represented by first avatar 410, has set up a game table 420 with a chess board and chess pieces (not shown) which the first avatar has effectively brought to the location 405. In this example, the first user may be inviting a second user, represented by a second avatar 430, to engage in a game of chess using the game table/chess board 420. It must be understood that the first avatar 410, the game table/chess board 420 and the second avatar are elements generated by an environment server, such as the environment servers 120, 320 and rendered on a display of a user device or virtual reality device such as 140, 150, 160, 340.

As the first avatar 410 moves through the three-dimensional virtual environment 400, the first avatar 410 does not necessarily carry the game table/chess board 420. Rather, the game table/chess board 420 may be collapsed and carried, metaphorically, in the first avatar's pocket (e.g. in an in-game inventory associated with a given account, avatar, or user). A user may have an inventory of multiple interactive objects that can be “popped up” within the three-dimensional virtual environment as the user desires.

The game table/chess board 420 is an example of a portable interactive object. In this context, an “interactive object” is an object with the three-dimensional virtual environment capable of interacting with one or more users via the user's avatars. A “portable interactive object” is an interactive object that may be repositioned within the three-dimensional virtual environment by a user. Other examples of possible interactive objects include, but are not limited to, a game table for playing other card games or board games. a pinball machine, a pool table, a swimming pool or hot tube, a bouncy house, an entire “game” in which players shoot and move about, a player-versus-player arena, an entire storefront or automated store (e.g. with an NPC minding the store) for sale of items, a couch or living room, a DJ deck or boombox for creating or playing music, a movie screen or display for presenting two-dimensional pictures or video (e.g. from the content database 336), or innumerable other objects. Subject to limitations, any user may use the object to create an impromptu movie viewing, card game, pool game, pool party, etc. while simply hanging out with friends within the metaverse.

Some content, such as movies and other video content, music, proprietary games (e.g. Monopoly® or Exploding Kittens®), or brand co-partnerships (e.g. a pop-up Coca-Cola® vending machine within the environment) may require a license or other permission to be incorporated in or presented on a portable interactive object.

In another example of a portable interactive object, a player may access a portable storefront that, when activated, allows the player to place the storefront in a location and orientation within the virtual environment as desired by the player. The player may elect to temporarily place the storefront within the environment or otherwise make it available. The storefront may incorporate sufficient programming—in the form of user-generated content or publicly available automations—to enable it to function without intervention of the player reliant upon prices set by the player. Thereafter, once set up, the player or others may interact with the portable storefront to add new items to the store (in the case of the player) and to purchase items from the store (in the case of other, nearby players).

In yet another example, a portable interactive object may be a sumo wrestling mat that acts as a sumo minigame for players that engage. The player may access the mat in the player's inventory, and place it within the world. Thereafter, two competitors nearby may interact with the mat to take part in a sumo minigame. After a match is completed, the mat may reset and allow others to participate. It is anticipated that players could create their own minigames or portable interactive objects, potentially selling the design to others, and that other designs may be made available for everyone or made available from a developer of the system. Even the rules of the game (e.g. the sumo match) could be set or altered by a player. For example, the mat may also include rules that indicate that the winning player continues to participate (unless they quit) to “defend their title” against the next competitor. The sumo game may display a “streak” score showing how many matches in a row the current winner has won or showing the longest streak overall for any participant.

In yet another example, a portable interactive object may be an entire race track for a racing simulation game. The race track may appear merely as a portal into which players can step to participate in a racing game. The portal exterior may display the current race—potentially even streaming video of the current race—or may be display the current status of the race (e.g. the players positions in the race and the time elapsed). The portal may enable players to enter the race and participate, complete with built-in cars, 4×4s, motorcycles, airplanes or the like. Or, alternatively, the race may enable racers to select vehicles from their own inventories to take part in the race. Though described as a portal, the portal may take many forms, such as a mini race track, old-style rail-car race track systems, a car (e.g. for the race), an arcade game cabinet showing a “race” themed game, a tabletop game, a toy car, or various other visible metaphors for the race game. Other game types are possible too, fighting games (e.g. 1 player vs 1 player), team combat games (e.g. many players vs many other players), puzzle games, etc. using similar metaphors like a “portal” style entrance. Alternatively, the actual race track may be placed in the environment, assuming there are no restrictions on placement of large portable interactive objects in a given space and there is sufficient space or place for such a race.

Players may charge or otherwise require certain thresholds be met before players are entitled to participate in a given portable interactive object. So, for example, if a player designs a particularly compelling race track, the player may charge an entrance fee to join the race. The player may likewise offer prizes for participation in or the outcome of any portable interactive object—like the race track. It is envisioned that particularly popular portable interactive objects may become popular destinations, players may “follow” a given user to the new location for a given portable interactive object and may receive larger rewards, offering larger payments to participate, to enjoy particular portable interactive objects.

In other cases, the portable interactive objects may be simple, like the chess game, or a simple Pong-style game, ways for players to kill time while hanging out together, or waste time until another event takes place. Much as real-world people desire to “hang out” without much of any particular goal in mind, and tend to occupy themselves with things, the portable interactive objects may serve a similar time-passing purpose.

In order for an avatar to carry and set up a particular interactive object, the user corresponding to the avatar must have access to that interactive object. A user may gain access to a specific interactive object by creating the interactive object, which is to say developing and uploading the code and data required for an environmental server to generate the interactive object. A user may create the object by piecing together in-game content in a unique way, e.g. by connecting many pieces to put together a functional chess board with the associated ruleset. That object may then be sold by the user or offered to other users for free through an in-metaverse store. Alternatively, a user may purchase a copy of an interactive object from another user or from a real or virtual store. The entity that hosts or otherwise created the metaverse may offer one or more interactive objects for sale or for free to some or all users. Such objects may be provided as gifts or in reward for certain accomplishments within the metaverse. A user may gain the right to access an interactive object in some other manner.

A user's ability to place a portable interactive object within the three-dimensional virtual environment may be subject to limitations. For example, a portion of the environment dedicated to a first-person shooter game may prohibit placement of portable objects between the shooters and intended targets. Other portions of the interactive environment may allow placement of portable interactive objects but may, for example, have a time limit or a limit on the number of portable objects allowed. Other locations may not allow any such objects to be placed, while other locations may allow all objects to be placed.

As with other user-generated environments and objects, a user may take time and use tools to create a portable interactive object for sale or otherwise to be used by other users within the three-dimensional virtual environment. There may be a flourishing third-party market for such diversions within the three-dimensional virtual environment to encourage users to simply “hang out” in the environment with their friends. A portable interactive object could even be an entire store or a party. A user may open the store or party and it may fill the space in which it is opened or operate as a store (enabling sales, taking payments, etc.) only to be put back in the user's pocket upon completion of interaction or after that user logs off.

A user's portable interactive object could also have a real-time representation at a different location within the three-dimensional virtual environment, with data pertaining to the use of the portable interactive object updated in real time. So, a user could “pop-up” their portable interactive object in a location, then go back to a residence location in the three-dimensional virtual environment (or simply have a status object in their inventory or that also may be popped-up somewhere else) where the user can monitor the real-time state of the portable interactive object. So, a user could “check-in” on their game board to see players playing the game, shoppers browsing the store, and the like while not actually at that location. The representation could simply be a “video feed” like interface but is preferably a real-time three-dimensional representation of the portable interactive object visible within the three-dimensional virtual environment in a fashion similar to a small model of a larger architectural project, except where the model updates in real-time to reflect the actual state of the portable interactive object as it changes in the moment.

The interactive object itself may be a user's home which, due to the ability of the metaverse to recreate data in multiple locations, can be updated with any interactions that take place in either “location” within the game world—a real location within the game and the interactive object “pop up” home in the location where it has been placed. There would be no need for friends to “go back to my place” when one's place exists anywhere one places the pop up “home” within the virtual environment.

Where there are limitations (e.g. certain streaming content may only be viewed by certain viewers or is only licensed in certain countries), a pop-up movie screen or movie theater may check that those viewing the screen have access rights or other permissions to actually view the content being shown or to play a game being played on the screen. Where a pop-up relates to an influencer-style activity (e.g. playing a game, reviewing a product, etc.), a user may be empowered to charge other users to continue viewing the activity.

Description of Processes

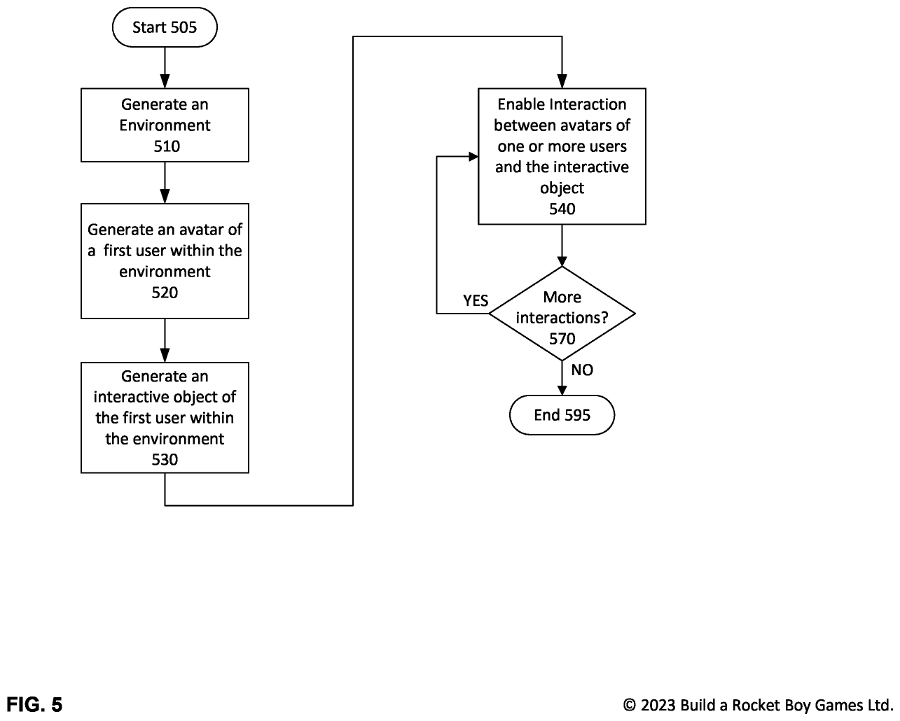

FIG. 5 is a flowchart of a process 500 for interacting with a portable interactive object in a three-dimensional virtual environment. The process 500 starts at 505, for example when a first users goes online, and ends at 595. The process 500 may be repeated at will by the first user and multiple instances of the process 500 may occur concurrently for a corresponding number of users.

At 510 a three-dimensional virtual environment may be generated and provided to a computing device of a first user. The three-dimensional virtual environment may be generated by an environment server such as the servers 120, 320. The computing device of the user may be, for example, the user computing device 140, the user mobile computing device 150, or, preferably, the virtual reality device 160. In some cases, the three-dimensional virtual environment may be generated continuously by an environment server and a portion of the three-dimensional virtual environment may be provided to the first user at 510.

Next a three-dimensional character or avatar representing the first user is generated within the environment at 520. This process involves the first user a computing device, such as the user computing device 340, to login to an environment server, such as the environment server 320 as confirmed by an authentication function 325. As a result, the environment server and user computing device together generate a three-dimensional virtual environment in which the first user's avatar may move about and interact.

At 530, an interactive object of the first user may be generated and placed within the three-dimensional virtual environment at a position selected by the first user via the first user's avatar. The position of the interactive object may typically, but not necessarily be proximate the first user's avatar generated at 520. As previously described, the placement of the interactive object may subject to limitations and may be prohibited in some portions of the three-dimensional virtual environment.

At 540, the interactive object placed at 530 interacts with one or more avatars which may include the first user's avatar. The nature and duration of the interaction may depend on the type and capabilities of the interactive object. In example of FIG. 4, the two users may play, via their respective avatars, a game of chess. Other possible interactions include, but are not limited to, playing other card games or board games, playing a pinball machine, playing pool on a pool table, swimming in a pool or soaking in a hot tube, jumping in a bouncy house, creating or playing music with DJ deck or boombox, and watching a movie screen or display presenting two-dimensional pictures or video.

The interactions at 540 may continue until a determination is made that no more interactions will occur (“no” at 570). A determination that no more interactions will occur may be made, for example, when no more avatars are present at the interactive object or when none of the avatars present indicate a desire for further interaction. A determination that no more interactions will occur may be made, for further example, when the first user intends to log out of, or move to a different location within, the three-dimensional virtual environment.

When a determination is made that no more interaction will occur, the process 500 ends at 595.

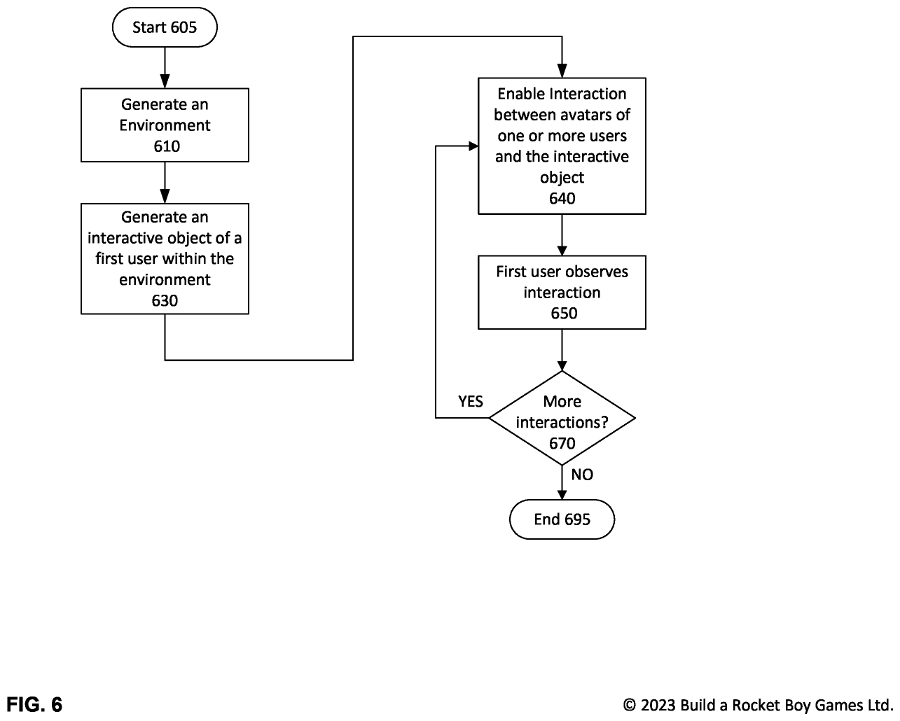

FIG. 6 is a flowchart of another process 600 for interacting with a portable interactive object in a three-dimensional virtual environment. The process 600 starts at 605, for example when a first users goes online, and ends at 695. The process 600 may be repeated at will by the first user and multiple instances of the process 600 may occur concurrently for a corresponding number of users.

At 610 a three-dimensional virtual environment may be generated and provided to a computing device of a first user. Next a three-dimensional character or avatar representing the first user is generated within the environment at 620. At 630, an interactive object of the first user may be generated and placed within the three-dimensional virtual environment. The actions at 610, 620, and 630 are essentially the same as the corresponding actions in the process 500 (FIG. 5), and further descriptions of these action will not be repeated.

At 635, the first avatar moves to a different location within the three-dimensional virtual environment. For example, the first avatar may go back to a residence location or some other location in the three-dimensional virtual environment.

At 640, the interactive object placed at 630 interacts with one or more avatars other than the first user's avatar. The nature and duration of the interaction may depend on the type and capabilities of the interactive object as previously described with regards to 530 with the process 500 of FIG. 5.

At 650, the first user may remotely monitor and/or observe the interactions occurring at 640. In this context, “remotely monitoring” means monitoring the interactive object when the first avatar is in a location (within the three-dimensional virtual environment) remote from the location of the interactive object. For example, the interaction object placed at 630 may have a real-time representation at a different location within the three-dimensional virtual environment, with data pertaining to the use of the portable interactive object updated in real time. In this case, the first user could “pop-up” their portable interactive object in a location at 630, move to a different location at 635, and then monitor the real-time state of the portable interactive object from the new location at 650. For example, at 650, the first user could “check-in” on their game board to see players playing the game, shoppers browsing the store, and the like while not actually at that location. The representation of the interactive object could simply be a “video feed” like interface but is preferably a real-time three-dimensional representation of the portable interactive object visible within the three-dimensional virtual environment in a fashion similar to a small model of a larger architectural project, except where the model updates in real-time to reflect the actual state of the portable interactive object as it changes in the moment.

The interactions at 640 and monitoring at 650 may continue until a determination is made that no more interactions will occur (“no” at 670), as previously described for the action 570 of the process 500 of FIG. 5. When a determination is made that no more interaction will occur, the process 600 ends at 695.

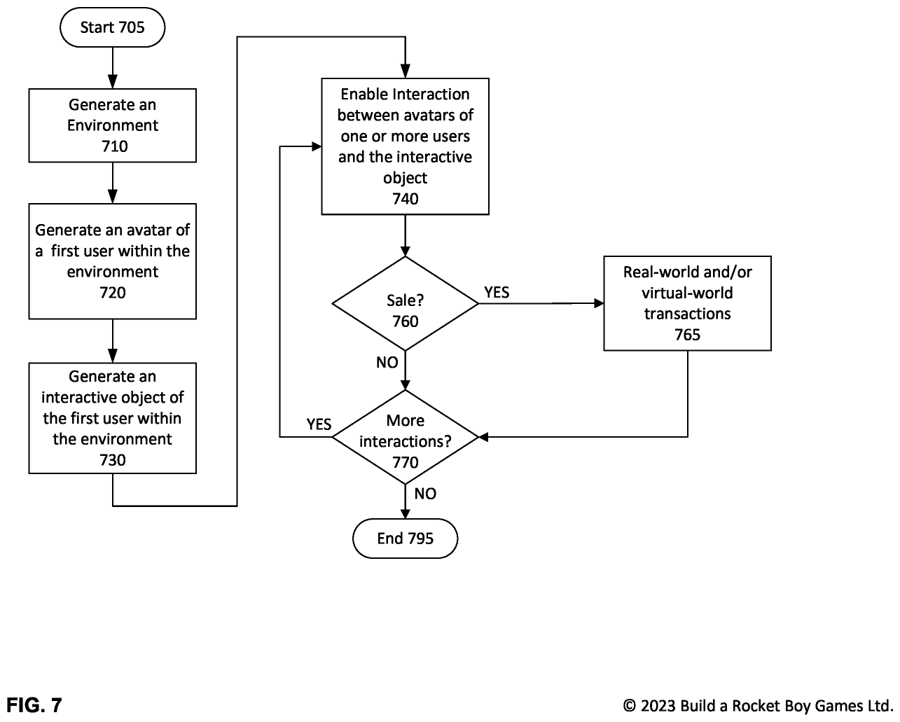

FIG. 7 is a flowchart of another process 700 for interacting with a portable interactive object in a three-dimensional virtual environment. The process 700 starts at 705, for example when a first users goes online, and ends at 795. The process 700 may be repeated at will by the first user and multiple instances of the process 700 may occur concurrently for a corresponding number of users.

At 710 a three-dimensional virtual environment may be generated and provided to a computing device of a first user. Next a three-dimensional character or avatar representing the first user is generated within the environment at 720. At 730, an interactive object of the first user may be generated and placed within the three-dimensional virtual environment. At 740, the interactive object placed at 730 interacts with one or more avatars which may include the first user's avatar. The actions at 710, 720, 730, and 740 are essentially the same as the corresponding actions in the process 500 (FIG. 5), and further descriptions of these action will not be repeated.

At 760, a determination is made if one or more users want to purchase or otherwise acquire a copy of the interactive object generated at 730. This determination may be made during, between, or after interactions between the interactive object and one or more avatars at 740. When a user wants to purchase a copy of the interactive object (“yes” at 760), virtual and/or real-world transactions will occur at 765. The virtual transaction may be as simple as an avatar pressing a “buy me” button on the interactive object or as complex as opening a virtual store where the user may purchase the interactive object and possibly other objects from the first user. U.S. Pat. No. 11,471,775, which is incorporated herein by reference, describes techniques for purchasing virtual objects using virtual and real-world transactions.

The interactions at 740 and the opportunity to purchase the interactive object may continue until a determination is made that no more interactions will occur (“no” at 770), as previously described for the action 570 of the process 500 of FIG. 5. When a determination is made at 770 that no more interaction will occur, the process 700 ends at 795.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for controlling an interactive virtual environment comprising a computing device for:
generating a three-dimensional virtual environment including a first avatar representing a first user within the three-dimensional virtual environment;
generating a portable interactive object of the first user at a first location within the three-dimensional virtual environment, the first location designated by the first user; and
the interactive object interacting with one or more avatars representing respective users.

2. The system of claim 1 wherein the one or more avatars includes at least one avatar other than the first avatar.

3. The system of claim 1 wherein the computing device is further for:
moving the first avatar to a second location within the three-dimensional virtual environment, the second location designated by the first user; and
the first user remotely monitoring the interactive object.

4. The system of claim 1 wherein the computing device is further for:
offering the interactive object for sale; and
conducting virtual and real-world transactions if the offer for sale is accepted by one or more of the users represented by the one or more avatars.

5. The system of claim 1 wherein the interactive object is a storefront that enables one or more avatars to shop within the three-dimensional virtual environment.

6. The system of claim 1 wherein the interactive object is one of a game table, a pinball machine, a pool table, a swimming pool, a hot tub, a bouncy house, a DJ deck, a boombox, a movie screen, and a display.

7. The system of claim 1 wherein the interactive object interacting with one or more avatars comprises the one or more avatars playing a card game, playing a board game, playing a pinball machine, playing pool on a pool table, swimming in a pool, soaking in a hot tube, jumping in a bouncy house, creating music with a DJ deck, playing music with a boombox, and watching a movie screen or display presenting two-dimensional pictures or video.

8. A method for controlling an interactive virtual environment using a computing device, the method comprising:
generating a three-dimensional virtual environment including a first avatar representing a first user within the three-dimensional virtual environment;
generating a portable interactive object of the first user at a first location within the three-dimensional virtual environment, the first location designated by the first user; and
the interactive object interacting with one or more avatars representing respective users.

9. The method of claim 8 wherein the one or more avatars includes at least one avatar other than the first avatar.

10. The method of claim 8 further comprising:
moving the first avatar to a second location within the three-dimensional virtual environment, the second location designated by the first user; and
the first user remotely monitoring the interactive object.

11. The method of claim 8 further comprising:
offering the interactive object for sale; and
conducting virtual and real-world transactions if the offer for sale is accepted by one or more of the users represented by the one or more avatars.

12. The method of claim 8 wherein the interactive object is one of a game table, a pinball machine, a pool table, a swimming pool, a hot tub, a bouncy house, a DJ deck, a boombox, a movie screen, and a display.

13. The method of claim 8 wherein the interactive object interacting with one or more avatars comprises the one or more avatars playing a card game, playing a board game, playing a pinball machine, playing pool on a pool table, swimming in a pool, soaking in a hot tube, jumping in a bouncy house, creating music with a DJ deck, playing music with a boombox, and watching a movie screen or display presenting two-dimensional pictures or video.

14. An apparatus comprising a non-volatile machine-readable medium storing a program having instructions which when executed by a computing device cause the computing device to perform actions comprising:
generating a three-dimensional virtual environment including a first avatar representing a first user within the three-dimensional virtual environment;
generating a portable interactive object of the first user at a first location within the three-dimensional virtual environment, the first location designated by the first user; and
the interactive object interacting with one or more avatars representing respective users.

15. The apparatus of claim 14 wherein the one or more avatars includes at least one avatar other than the first avatar.

16. The apparatus of claim 14, the actions further comprising:
moving the first avatar to a second location within the three-dimensional virtual environment, the second location designated by the first user; and
the first user remotely monitoring the interactive object.

17. The apparatus of claim 14, the actions further comprising:
offering the interactive object for sale; and
conducting virtual and real-world transactions if the offer for sale is accepted by one or more of the users represented by the one or more avatars.

18. The apparatus of claim 14 wherein the interactive object is one of a game table, a pinball machine, a pool table, a swimming pool, a hot tub, a bouncy house, a DJ deck, a boombox, a movie screen, and a display.

19. The apparatus of claim 14 wherein the interactive object interacting with one or more avatars comprises the one or more avatars playing a card game, playing a board game, playing a pinball machine, playing pool on a pool table, swimming in a pool, soaking in a hot tube, jumping in a bouncy house, creating music with a DJ deck, playing music with a boombox, and watching a movie screen or display presenting two-dimensional pictures or video.

20. The apparatus of claim 14 further comprising:
the processor; and
a memory,
wherein the processor and the memory comprise circuits and software for performing the instructions on the storage medium.
